(19) United States
(12) Patent Application Publication
(10) Pub. No.: US 2025/0100906 A1
(43) Pub. Date: Mar. 27, 2025

(54) WASTEWATER FLUID STORAGE TANK AND METHOD OF USE

(71) Applicant: Oceaneering International, Inc., Houston, TX (US)

(72) Inventors: John FRICKER, Taylor Lake Village, TX (US); Tatsuya ARAI, League City, TX (US)

(73) Assignee: Oceaneering International, Inc., Houston, TX (US)

(21) Appl. No.: 18/899,217

(22) Filed: Sep. 27, 2024

Related U.S. Application Data
(60) Provisional application No. 63/585,867, filed on Sep. 27, 2023.

(51) Int. Cl. C02F 1/44; C02F 1/467

(52) U.S. Cl. CPC C02F 1/44; C02F 1/4672; C02F 2201/002

(57) ABSTRACT

A brine bag may be used in a wastewater management system and typically comprises a hydrophobic outer filter bag, comprising a fluid permeable membrane; a hydrophilic inner bag disposed at least partially within the hydrophobic outer filter bag and comprising a liquid and fluid permeable membrane; a wastewater inlet pathway sealed to and in fluid communication with the hydrophilic inner bag at a sealing point; and a wastewater outlet pathway in fluid communication with the hydrophobic outer bag.

### CROSS-REFERENCE TO RELATED APPLICATIONS

This application claims priority through U.S. Provisional Application 63/585,867 filed on Sep. 27, 2023.

### BACKGROUND OF THE INVENTION

Separators may be required for use as part of a urinal to separate urine and air, especially as it applies to separating two-phase fluids in microgravity. Referring generally to FIG. 2, traditionally in zero-G, a urinal sucks both gas and liquid into the urinal using reduced pressure and separates liquid from gas with a spin separator in which liquid touches and adheres to a spinning drum wall which slings the liquid out to the sides. The spinning liquid rams into a pitot tube which pressurizes the liquid and pushes it out of the drum. These systems are large, have moving parts, and are susceptible to clogging.

A wastewater management system in space applications produces concentrated wastewater or “brine” at the end of the process after water is removed from the wastewater. In order to recover even more water out of the brine, the brine is offloaded into a bag that selectively passes water vapor. Air (sweep gas) is blown over the bag to evaporate the water. The bag or sweep gas is typically heated to expedite water evaporation. The selectivity of the bag membrane also passes other gas species that vaporize so a gas scrubber is needed to remove offensive trace contaminants before returning the sweep gas to the cabin. In embodiments of this type of system brine is offloaded from the urine processor into a brine bag, then the brine bag is placed in the brine processor.

In U.S. Pat. No. 11,365,137, referring to FIG. 1, wastewater (comprising urine, greywater, blackwater, or the like or a combination thereof) is stored in the tank. As the process starts, the pump circulates wastewater in the loop. The redox cell electrochemically processes wastewater to oxidize and reduce wastewater constituents. Gas bubbles and foams generated by the electrochemical process leave the wastewater loop from porous lumens in a gas-liquid contactor (GLC). The degassed wastewater returns to the tank and recirculates until the electrochemical process and evaporation are completed.

### BRIEF DESCRIPTION OF DRAWINGS

Various figures are included herein which illustrate aspects of embodiments of the disclosed inventions.

FIG. 1 is a flow diagram for an electro-oxidation membrane evaporator wastewater processor;

FIG. 2 is a flow diagram for a traditional gas-liquid separation system;

FIG. 3 is a block diagram an exemplary brine bag;

FIG. 4 is a block diagram of an embodiment of showing use of the exemplary brine bag;

FIG. 5 is a block diagram of an embodiment of showing use of the exemplary brine bag in an electro oxidation and membrane evaporator (“EOME”) configuration; and

FIG. 6 is a block diagram of an embodiment of showing use of the exemplary brine bag in an EOME configuration with replaceable brine bags.

### DETAILED DESCRIPTION OF EMBODIMENTS OF THE INVENTION

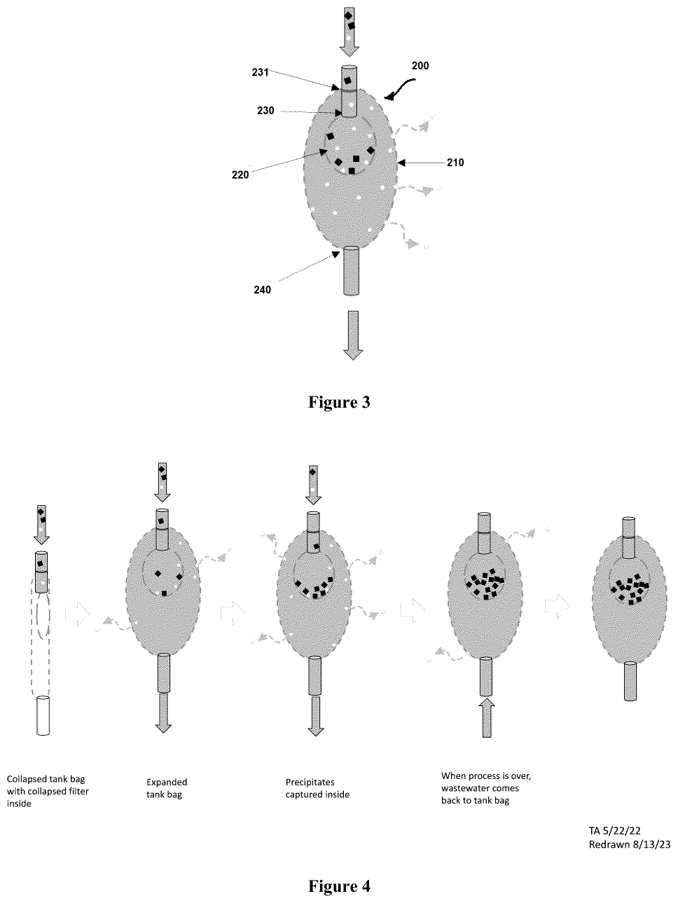

Referring to FIG. 3, brine bag 200 comprises hydrophobic outer filter bag 210, comprising a fluid permeable membrane; hydrophilic inner bag 220 disposed at least partially within hydrophobic outer filter bag 210 and comprising a liquid and fluid permeable membrane; one or more wastewater inlet pathways 230 in a sealed arrangement with, e.g., sealed to, and in fluid communication with hydrophilic inner bag 220 at sealing point 231; and one or more wastewater outlet pathways 240, which may be bidirectional, in fluid communication with hydrophobic outer filter bag 210.

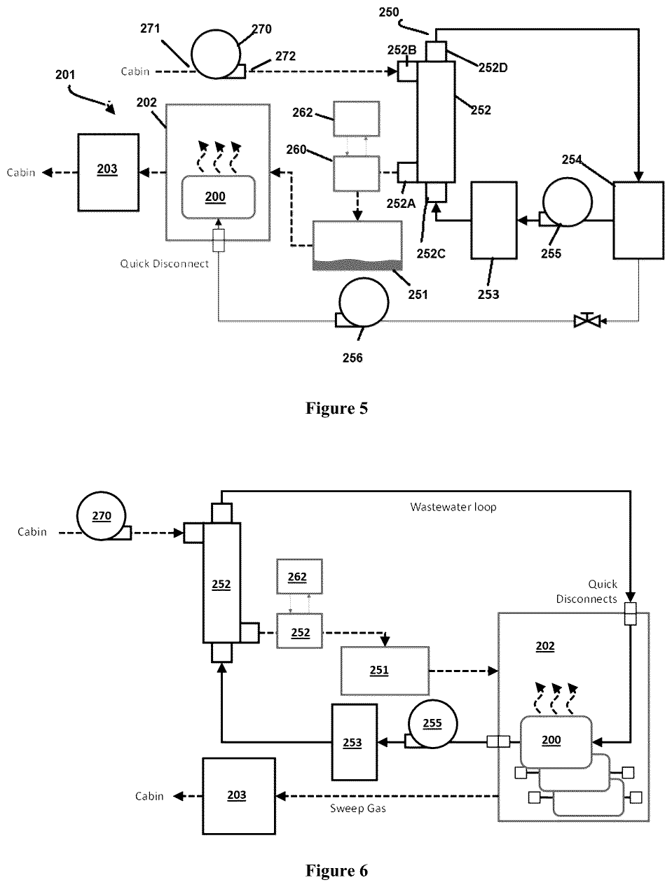

Referring now addition to FIG. 5, wastewater management system 201 comprises enclosure 202; one or more brine bags 200, as described above, disposed at least partially within enclosure 202 where the fluid permeable membrane is configured to allow a fluid to pass through hydrophobic outer filter bag 210 into enclosure 202; one or more gas scrubbers 203 disposed downstream of enclosure 202 and in fluid communication with enclosure 202; one or more wastewater processors 250; one or more redox cells (253) in fluid communication with wastewater inlet 252C; one or more wastewater tanks 254, comprising at least one wastewater outlet 252D, in fluid communication with redox cell 253 and wastewater outlet 252D; one or more first pumps 255 disposed intermediate redox cell 253 and in fluid communication with wastewater tank 254; one or more condensing heat exchangers 260 disposed upstream from, and in fluid communication with, sweep gas outlet 252A of gas-liquid contractor 252 and disposed downstream of, and in fluid communication with, one or more condensation tanks 251; one or more chillers 262 in fluid communication with condensing heat exchanger 252; and one or more fans 270.

Wastewater processors 250 typically comprise one or more condensation tanks 251 in fluid communication with enclosure 202 and one or more gas-liquid contractors 252. Gas-liquid contractors 252 typically comprise at least one sweep gas outlet 252A; at least one sweep gas inlet 252B; at least one wastewater inlet 252C; and at least one wastewater outlet 252D.

Typically, at least one fan 270 comprises fluid inlet 271 and fluid outlet 272 in fluid communication with sweep gas inlet 252B of gas-liquid contractor 252. Fluid inlet 271 is typically in fluid communication with a fluid reservoir such as a cabin.

In embodiments, wastewater management system 201 further comprises one or more transfer pumps 256 in fluid communication with an inlet of brine bag (200) and with one of the outlets of the wastewater tank (254) and configured to provide automatic transfer of brine from wastewater tank 254 to brine bag 200 in enclosure 202. In embodiments, transfer pumps 256 may be configured to allow manual transfer of brine from wastewater tank 254 to brine bag 200 in enclosure 202.

Referring now additionally to FIG. 6, wastewater management system 204 comprises wastewater processor 204 comprising enclosure 202; brine bag 200 disposed at least partially within 202 enclosure, where brine bag 200 is as described above, and where wastewater inlet pathway 230 is configured to accept wastewater that comprises a fluid and a solid mass; one or more condensation tanks 251 in fluid communication with enclosure 202; one or more gas-liquid contractors 252, as described above; one or more redox cells 253 in fluid communication with wastewater inlet 252C; one or more wastewater tanks 254 comprising wastewater outlet 252D and in fluid communication with at least one redox cell 253 via wastewater outlet 252D; one or more first pumps 255 disposed intermediate redox cell 253 and brine bag 200, at least one first pump 255 in fluid communication with an outlet of brine bag 200 and with an inlet of redox cell 253; one or more transfer pumps 256 in fluid communication with an inlet of brine bag 200 and with at least one of the outlets of wastewater tank 254; one or more condensing heat exchangers 260 disposed upstream from, and in fluid communication with, condensation tank 251, at least one condensing heat exchanger 260 disposed downstream of, and in fluid communication with, sweep gas outlet 252D of gas-liquid contractor 252; one or more chillers 262 in fluid communication with condensing heat exchanger 252; and one or more fans 270.

One or more gas scrubbers 203 are typically disposed downstream of, and are in fluid communication with, enclosure 202 where gas scrubbers 203 are typically in fluid communication with a fluid reservoir such as a cabin.

At least one fan 270 typically comprises fluid inlet 271 (FIG. 5) and fluid outlet 272 (FIG. 5) in fluid communication with sweep gas inlet 252B of gas-liquid contractor 252.

Gas-liquid contractors 252 typically comprise one or more wastewater outlets 252D; one or more sweep gas inlets 252B; one or more wastewater inlets 252C; and one or more sweep gas outlets 252A.

In embodiments, brine bag 200 comprises a selectively replaceable tank bag which is replaceable inside enclosure 202 with a new brine bag 200 such as by using a quick disconnect. In these embodiments, a replaced brine bag 200 may be left inside enclosure 202 and a liquid such as water allowed to continue to evaporate out of brine present in brine bag 200 and/or enclosure 202 into sweep gas while brine is stored in enclosure 202.

In embodiments, brine bag 200 comprises a plurality of replaceable brine bags 200 that can be stored in enclosure 202 so water recovery from brine in a replaced brine bag occurs in parallel with normal urine processing.

If volume is designed into the enclosure allowing storage of 3 for example old tank bags, and one is rotated out after each change of the wastewater loop tank bag, it will allow weeks or months of brine drying for each tank bag.

In the operation of exemplary methods, referring back to FIG. 4, brine bag 200 may be evacuated or otherwise in a collapsed state. Fluid enters into and expands hydrophilic inner bag 220, the fluid comprising liquid, precipitates, and, potentially, gas. Precipitates are captured and trapped within hydrophilic inner bag 220 fluid permeable membrane and liquids and, if present, gases are allowed to escape the fluid permeable membrane into, and expand, hydrophobic outer filter bag 210. In embodiments, fluid is allowed to exit hydrophobic outer filter bag 210 via one or more wastewater outlet pathways 240. At a predetermined time, such as when brine processing function processing has completed, fluid may be allowed to reenter hydrophobic outer filter bag 210 via one or more wastewater outlet pathways 240.

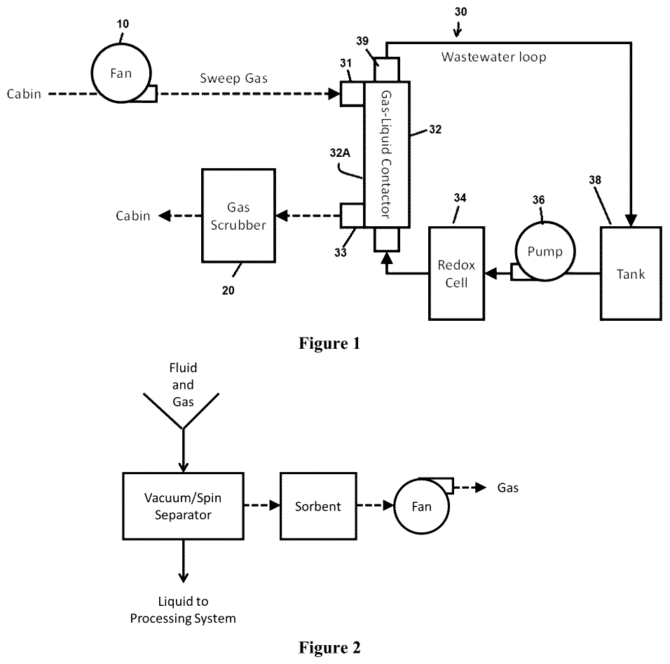

In additional embodiments, the above described brine processing function may be incorporated into an EOME wastewater management system (shown in FIG. 1). Typically, condensing heat exchanger 260 is placed downstream of a sweep gas side of gas-liquid contactor 252, efficiently condensing water at the most humid and warmest location of wastewater system 201 or 250, and thus drying the air to be an effective sweep gas for evaporating water from the brine bag in the downstream enclosure. Enclosure 202 is placed downstream of condensing heat exchanger 260 and upstream of an (existing) gas scrubber 203. Unlike the current state of the art brine bag assembly, this configuration takes advantage of existing gas scrubber, so trace contaminants that are off-gassed with water vapor are removed prior to returning the sweep gas and water vapor to the cabin. As described above, a wastewater tank itself can be a brine bag (act as a “tank bag”) if it is located in enclosure 202 so off-gassing volatile components are captured by the downstream scrubber. Towards the end of the EOME process after the desired level of concentration has been reached during the wastewater loop circulation phase, brine bag 200 may be replaced with a new brine bag 200 such as by using quick disconnects inside enclosure 202. The old brine bag 200 may be left in enclosure 202 and water allowed to continue to evaporate out of the brine into sweep gas while brine is stored in enclosure 202. Multiple brine bags 200 can be stored in enclosure 202 so water recovery from brine in old brine bags 200 occurs in parallel with normal urine processing. If volume is designed into enclosure 202 allowing storage of a plurality of brine bags 200, e.g., three, and one brine bag 200 is rotated out after each change of the wastewater loop tank bag, it will allow weeks or months of brine drying for each tank bag.

The foregoing disclosure and description of the inventions are illustrative and explanatory. Various changes in the size, shape, and materials, as well as in the details of the illustrative construction and/or an illustrative method may be made without departing from the spirit of the invention.

1. A brine bag, comprising:
a) a hydrophobic outer filter bag, comprising a fluid permeable membrane;
b) a hydrophilic inner bag disposed at least partially within the hydrophobic outer filter bag, the hydrophilic inner bag comprising a liquid and fluid permeable membrane;
c) a wastewater inlet pathway sealed to and in fluid communication with the hydrophilic inner bag at a sealing point; and
d) a wastewater outlet pathway in fluid communication with the hydrophobic outer filter bag.

2. A wastewater management system, comprising:
a) an enclosure;
b) a brine bag disposed at least partially within the enclosure, comprising:
i) a hydrophobic outer filter bag, comprising a fluid permeable membrane that is configured to allow a fluid to pass through the hydrophobic outer filter bag into the enclosure;
ii) a hydrophilic inner bag disposed at least partially within the hydrophobic outer filter bag, comprising a liquid and fluid permeable membrane configured to retain a solid mass within the hydrophilic inner bag;
iii) a wastewater inlet pathway sealed to and in fluid communication with the hydrophilic inner bag, the wastewater inlet pathway configured to accept wastewater that comprises the fluid and the solid mass; and
iv) a wastewater outlet pathway in fluid communication with the hydrophobic outer filter bag;
c) a gas scrubber disposed downstream of, and in fluid communication with, the enclosure;
d) a wastewater processor, comprising:
i) a condensation tank in fluid communication with the enclosure;
ii) a gas-liquid contractor, comprising:
(1) a sweep gas outlet;
(2) a sweep gas inlet;
(3) a wastewater inlet; and
(4) a wastewater outlet;
e) a redox cell in fluid communication with the wastewater inlet;
f) a wastewater tank in fluid communication with the redox cell and the wastewater outlet;
g) a first pump disposed intermediate the redox cell and the brine bag, the first pump in fluid communication with an outlet of the brine bag and with an inlet of the redox cell;
h) a condensing heat exchanger disposed upstream from, and in fluid communication with, the enclosure, the condensing heat exchanger disposed downstream of, and in fluid communication with, the sweep gas outlet of the gas-liquid contractor;
i) a chiller in fluid communication with the condensing heat exchanger; and
j) a fan comprising:
i) a fluid inlet; and
ii) a fluid outlet in fluid communication with the sweep gas inlet of the gas-liquid contractor.

3. The wastewater management system of claim 2, further comprising a transfer pump in fluid communication with an inlet of brine bag and with one of the outlets of the wastewater tank, the transfer pump configured to allow automatic or manual transfer of brine from the wastewater tank to the brine bag in the enclosure.

4. A wastewater management system, comprising:
a) a wastewater processor, comprising:
i) an enclosure;
ii) a brine bag disposed at least partially within the enclosure, comprising:
(1) a hydrophobic outer filter bag, comprising a fluid permeable membrane, the fluid permeable membrane configured to allow a fluid to pass through the hydrophobic outer filter bag into the enclosure;
(2) a hydrophilic inner bag disposed at least partially within the hydrophobic outer filter bag, comprising a liquid and fluid permeable membrane configured to retain a solid mass within the hydrophilic inner bag;
(3) a wastewater inlet pathway sealed to and in fluid communication with the hydrophilic inner bag, the wastewater inlet pathway configured to accept wastewater than comprises the fluid and the solid mass; and
(4) a wastewater outlet pathway in fluid communication with the hydrophobic outer filter bag;
iii) a condensation tank in fluid communication with the enclosure;
iv) a gas-liquid contractor, comprising:
(1) a sweep gas outlet;
(2) a sweep gas inlet;
(3) a wastewater inlet; and
(4) a wastewater outlet;
v) a redox cell in fluid communication with the wastewater inlet;
vi) a wastewater tank in fluid communication with the redox cell and the wastewater outlet, the wastewater tank comprising an outlet;
vii) a first pump disposed intermediate the redox cell and the brine bag, the first pump in fluid communication with an outlet of the brine bag and with an inlet of the redox cell;
viii) a transfer pump in fluid communication with an inlet of the brine bag and with one of the outlets of the wastewater tank;
ix) a condensing heat exchanger disposed upstream from, and in fluid communication with, the condensation tank, the condensing heat exchanger disposed downstream of, and in fluid communication with, the sweep gas outlet of the gas-liquid contractor; and
x) a chiller in fluid communication with the condensing heat exchanger;
b) a gas scrubber disposed downstream of the enclosure and in fluid communication with the enclosure; and
c) a fan comprising:
i) a fluid inlet; and
ii) a fluid outlet in fluid communication with the sweep gas inlet of the gas-liquid contractor.

5. The wastewater management system of claim 4, wherein the brine bag comprises a selectively replaceable tank bag replaceable inside the enclosure with a new brine bag using a quick disconnect.

6. The wastewater management system of claim 5, wherein a replaced brine bag is left in the enclosure and water allowed to continue to evaporate out of brine present in the brine bag and/or the enclosure into sweep gas while brine present in the brine bag and/or the enclosure is stored therein.

7. The wastewater management system of claim 4, wherein the brine bag comprises a plurality of replaceable brine bags that can be stored in the enclosure so water recovery from brine in a replaced brine bag occurs in parallel with normal urine processing.

8. A method of wastewater treatment, comprising:
a) disposing a brine bag in an enclosure, the brine bag comprising a hydrophobic outer filter bag comprising a fluid permeable membrane, a hydrophilic inner bag disposed at least partially within the hydrophobic outer filter bag and comprising a liquid and fluid permeable membrane, a wastewater inlet pathway sealed to and in fluid communication with the hydrophilic inner bag at a sealing point, and a wastewater outlet pathway in fluid communication with the hydrophobic outer filter bag;
b) allowing a fluid to enter into and expand the hydrophilic inner bag, the fluid comprising a liquid and a precipitate;
c) capturing and trapping the precipitate within the fluid permeable membrane of the hydrophilic inner bag;
d) allowing the liquid to escape the fluid permeable membrane into, and expand, the hydrophobic outer filter bag;
e) at a predetermined time, allowing the fluid to reenter the hydrophobic outer filter bag via one or more wastewater outlet pathways.

9. The method of claim 8, further comprising incorporating the brine bag into an electro oxidation and membrane evaporator (“EOME”) wastewater management system comprising a condensing heat exchanger placed downstream of a sweep gas side of gas-liquid contactor, further comprising:
a) efficiently condensing the fluid at a most humid and warmest location of the wastewater management system; and
b) drying air to be an effective sweep gas for evaporating water from the brine bag in an enclosure that is placed downstream of the condensing heat exchanger and upstream of a gas scrubber;
c) removing off-gassed trace contaminants prior to returning the sweep gas and water vapor to a cabin.

10. The method of claim 9, wherein a wastewater tank located in the enclosure functions as a brine bag so off-gassing volatile components are captured by the gas scrubber.

11. The method of claim 9, wherein, towards the end of an EOME process after a desired level of concentration has been reached during a wastewater loop circulation phase, the method further comprises:
a) replacing a current brine bag with a new brine bag such as by using quick disconnects inside enclosure;
b) leaving the current brine bag in the enclosure; and
c) allowing water to continue to evaporate out of brine into the sweep gas while the brine is stored in the enclosure to allow water recovery from brine in the replaced brine bags to occurs in parallel with normal fluid processing.

12. The method of claim 8, wherein the brine bag is initially disposed in an evacuated or otherwise collapsed state.

13. The method of claim 8, wherein:
a) the fluid further comprises a gas; and
b) the gas is allowed to escape the fluid permeable membrane.

14. The method of claim 8, wherein the fluid is allowed to exit the hydrophobic outer filter bag via a wastewater outlet pathway.

15. The method of claim 8, wherein the predetermined time comprises a time when brine processing function processing has completed.
